(19) United States
(12) Patent Application Publication
(10) Pub. No.: US 2021/0179092 A1
(43) Pub. Date: Jun. 17, 2021

(54) ACTIVE SAFETY ASSISTANCE SYSTEM FOR PRE-ADJUSTING SPEED AND CONTROL METHOD USING THE SAME

(71) Applicant: AUTOMOTIVE RESEARCH & TESTING CENTER, Lugang (TW)

(72) Inventors: YING-REN CHEN, LUGANG (TW); SHUN-YOU LIN, LUGANG (TW); SIANG-MIN SIAO, LUGANG (TW); LI-YOU HSU, LUGANG (TW)

(21) Appl. No.: 16/715,231

(22) Filed: Dec. 16, 2019

(51) Int. Cl. B60W 30/09; G08G 1/16; B60W 40/04; B60W 10/04; B60W 10/18; B60W 10/20; B60W 30/095

(52) U.S. Cl. CPC B60W 30/09; B60W 2720/10; G08G 1/167; B60W 40/04; B60W 10/04; B60W 10/18; B60W 10/20; B60W 30/0956; B60W 2550/308; B60W 2550/30; B60W 2520/125; B60W 2520/10; B60W 2550/306; B60W 2550/146; G08G 1/166

(57) ABSTRACT

An active safety assistance system for pre-adjusting speed and a control method using the same detect whether there is one other vehicle around a host vehicle. The trajectory of the other vehicle neighboring the host vehicle is estimated when the other vehicle exists. After fitting the other-vehicle trajectory to a lane to determine the intention of the other vehicle, the method determines whether the other vehicle is used as a target vehicle that influences the movement of the host vehicle and calculates a control parameter according to the fitted result and the intention of the other vehicle. The method calculates a target speed and a steering-wheel angle of the host vehicle and controls a steering wheel, a throttle pedal and a brake force of the host vehicle according to the trajectory, the control parameter, and the target speed of the host vehicle.

### BACKGROUND OF THE INVENTION

### Field of the Invention

The present invention relates to a driver assisting safety system, particularly to an active safety assistance system for pre-adjusting speed and a control method using the same.

### Description of the Related Art

Advanced driver assistance systems (ADAS), used to assist drivers in controlling vehicle-driving systems, provides drivers with some pieces of information, such as working states of vehicles and environmental information outside vehicles. The ADAS use radars, lidars, satellite navigation, and computer vision to detect their surroundings to generate related information, and transforms the related information into suitable navigation paths, obstacles, and related signs to avoid obstacles or maintain a safe distance from obstacles (e.g., vehicles at the front, back, left, and right sides). Thus, drivers can early take appropriate measures according to road conditions to avoid traffic accidents and reduce the fatigue of drivers when the driver is driving a long way.

The vehicle starts a traffic jam assist (TJA) system to control a steering wheel, a brake, and a throttle when the vehicle advances at medium-low speed. In the market, the TJA system is divided into two types. One type is a longitudinal-controlling adaptive cruise control (ACC) system and the other type is a longitudinal-controlling and lateral-controlling integrated system (e.g., the level 2 of driving automation of society of automation engineers) that combines an ACC system with a lane keeping system (LKS). However, following a front vehicle at close range has an opportunity to influence lane detection due to the existence of the front vehicle when the vehicle speed is decreased to a specific value, such as less than 20 kilometers per hour. Thus, lanes are unstably recognized. Even if the vehicle is installed with an ACC system, an autonomous emergency braking (AEB) system, and a lane following system (LFS), lanes are difficultly recognized, causing the more difficulty for the control system.

To overcome the abovementioned problems, the present invention provides an active safety assistance system for pre-adjusting speed and a control method using the same.

### SUMMARY OF THE INVENTION

The primary objective of the present invention is to provide an active safety assistance system for pre-adjusting speed and a control method using the same, which predict the trajectories of a front vehicle and neighboring vehicles in left and right lanes. After the other-vehicle trajectory of one other vehicle is fitted to a lane, an intention that the other vehicle advances in the same lane, turns in the same lane, or switches over to another lane can be estimated to determine whether the other vehicle influences the movement of a host vehicle.

Another objective of the present invention is to provide an active safety assistance system for pre-adjusting speed and a control method using the same, which fit the other-vehicle trajectory to the trajectory of the host vehicle to find from other vehicles a target vehicle that influences the movement of the host vehicle, calculate control parameters of the host vehicle according to a distance between the host vehicle and the target vehicle, and the speed and the future trajectory of the host vehicle, and cooperates with the state data of the host vehicle to calculate a target speed that a driver feels comfortable.

Further objective of the present invention is to provide an active safety assistance system for pre-adjusting speed and a control method using the same, which make lateral and longitudinal decisions and control a steering-wheel angle, a brake force, and a throttle pedal according to a vehicle-following distance, a look-ahead distance from a front vehicle, a distance to collision, and time to collision, such that the host vehicle advances at target speed that the driver feels comfortable to achieve driving safety.

To achieve the abovementioned objectives, the present invention provides an active safety assistance system for pre-adjusting speed installed on an on-board system of a host vehicle. The active safety assistance system comprises: an other-vehicle trajectory estimation module configured to calculate a deviation amount of the host vehicle with respect to a lane center according to a plurality of environment-sensing data and estimate an other-vehicle trajectory of at least one other vehicle when the other-vehicle trajectory estimation module detects the at least one other vehicle around the host vehicle; an intention-analyzing module coupled to the other-vehicle trajectory estimation module and configured to fit the other-vehicle trajectory to at least one lane to determine that the at least one other vehicle intends to advance in the same lane, turn in the same lane or switch over to another lane, fit the other-vehicle trajectory to a dynamic trajectory of the host vehicle to generate a fitted result, and determine whether the at least one other vehicle is used as at least one target vehicle that influences movement of the host vehicle according to the fitted result and an intention of the at least one other vehicle, and the intention-analyzing module calculates at least one control parameter for fixing distance, fixing speed, or pre-adjusting speed of the host vehicle when the at least one target vehicle exists; a speed pre-adjusting module coupled to the intention-analyzing module and configured to receive the at least one control parameter and use the at least one control parameter to cooperate with the deviation amount, a speed, a lateral acceleration, and a plurality of state data of the host vehicle to calculate a target speed of the host vehicle; and a target-following decision-making module coupled to the intention-analyzing module and the speed pre-adjusting module and configured to make decisions for a steering wheel, a throttle pedal and a brake force of the host vehicle according to an intention of the at least one target vehicle, the dynamic trajectory, the at least one control parameter, and the target speed.

In an embodiment of the present invention, the plurality of environment-sensing data comprise a vehicle-width recognition result, longitudinal and lateral relative speeds, and a relative distance of the at least one other vehicle, the moving-state information of the host vehicle, a lane line-detecting result, and a lane-line model.

In an embodiment of the present invention, the other-vehicle trajectory estimation module substitutes the plurality of environment-sensing data into a four-dimensional Euclidean coordinate transforming formula, combines time and space, and uses a representative formula of

$${P}_{i} ( t ) = {min}_{P} ( Σ ‖ P ( {t}^{-} ) - {x}_{i , {t}^{-}} ‖ )$$

to obtain a future trajectory of the at least one other vehicle, wherein x_{i,t} represents the other-vehicle information of the i-th other vehicle at previous time t⁻ and P(t) is a quadratic function of time t.

In an embodiment of the present invention, the other-vehicle trajectory estimation module combines time and space to generate a combined result, and the intention-analyzing module uses the combined result to determine that the at least one other vehicle drives at the inside of a lane where the host vehicle presently drives, the left of the outside of a lane where the host vehicle presently drives, or the right of the outside of a lane where the host vehicle presently drives, thereby performing a lane-fitting process.

In an embodiment of the present invention, the plurality of state data comprise a vehicle-following distance that the host vehicle follows the at least one other vehicle, an average speed of vehicles driving in neighboring lanes, and a road curvature, and the speed pre-adjusting module determines whether a distance between the host vehicle and the at least one other vehicle is within a safe range to adjust the speed of the host vehicle and obtain the target speed according to the vehicle-following distance, the average speed of vehicles driving in neighboring lanes, the road curvature, the speed and the lateral acceleration of the host vehicle, and the intention of the at least one other vehicle determined by the intention-analyzing module.

In an embodiment of the present invention, the target-following decision-making module comprises a lateral integrated decision-making module, a longitudinal integrated decision-making module, and a vehicle movement-limiting module, the lateral integrated decision-making module is configured to control the steering wheel, and the longitudinal integrated decision-making module is configured to control the throttle pedal and the brake force.

In an embodiment of the present invention, the vehicle movement-limiting module is configured to calculate a vehicle speed and an acceleration for longitudinal limitation and a steering-wheel angle for lateral limitation according to decisions made by the lateral integrated decision-making module and the longitudinal integrated decision-making module, lest the host vehicle be overturned when passing through a curve.

The present invention also provides a control method using an active safety assistance system for pre-adjusting speed, which is applied to an on-board system of a host vehicle, and when the control method detects at least one other vehicle around the host vehicle, the control method comprises: using an other-vehicle trajectory estimation module to calculate a deviation amount of the host vehicle with respect to a lane center according to a plurality of environment-sensing data and estimate an other-vehicle trajectory of the at least one other vehicle; using an intention-analyzing module to fit the other-vehicle trajectory to at least one lane to determine that the at least one other vehicle intends to advance in the same lane, turn in the same lane or switch over to another lane, fit the other-vehicle trajectory to a dynamic trajectory of the host vehicle to generate a fitted result, and determine whether the at least one other vehicle is used as at least one target vehicle that influences the movement of the host vehicle according to the fitted result and the intention of the at least one other vehicle, and using the intention-analyzing module to calculate at least one control parameter for fixing distance, fixing speed, or pre-adjusting speed of the host vehicle when the at least one target vehicle exists; using a speed pre-adjusting module to receive the at least one control parameter and use the at least one control parameter to cooperate with the deviation amount, a speed, a lateral acceleration, and a plurality of state data of the host vehicle to calculate a target speed of the host vehicle; and using a target-following decision-making module to make decisions for a steering wheel, a throttle pedal and a brake force of the host vehicle according to an intention of the at least one target vehicle, the dynamic trajectory, the at least one control parameter, and the target speed.

Below, the embodiments are described in detail in cooperation with the drawings to make easily understood the technical contents, characteristics and accomplishments of the present invention.

### BRIEF DESCRIPTION OF THE DRAWINGS

FIG. 1 is a diagram illustrating an active safety assistance system for pre-adjusting speed according to an embodiment of the present invention;

FIG. 2 is a flowchart of an operation process of an other-vehicle trajectory estimation module and an intention-analyzing module according to an embodiment of the present invention;

FIG. 3 is a flowchart of an operation process of a speed pre-adjusting module according to an embodiment of the present invention;

FIG. 4 is a flowchart of an operation process of a target-following decision-making module according to an embodiment of the present invention;

FIG. 5 is a diagram illustrating a distance to collision between a host vehicle and a front vehicle according to an embodiment of the present invention;

FIG. 6 is a flowchart of an operation process of a lateral integrated decision-making module according to an embodiment of the present invention;

FIG. 7-1 and FIG. 7-2 are flowcharts of an operation process of a longitudinal integrated decision-making module according to an embodiment of the present invention; and

FIG. 8 is a diagram schematically illustrating a safe vehicle-following distance for longitudinal control, a preview distance for lateral control, and a safe vehicle-following time interval according to an embodiment of the present invention.

### DETAILED DESCRIPTION OF THE INVENTION

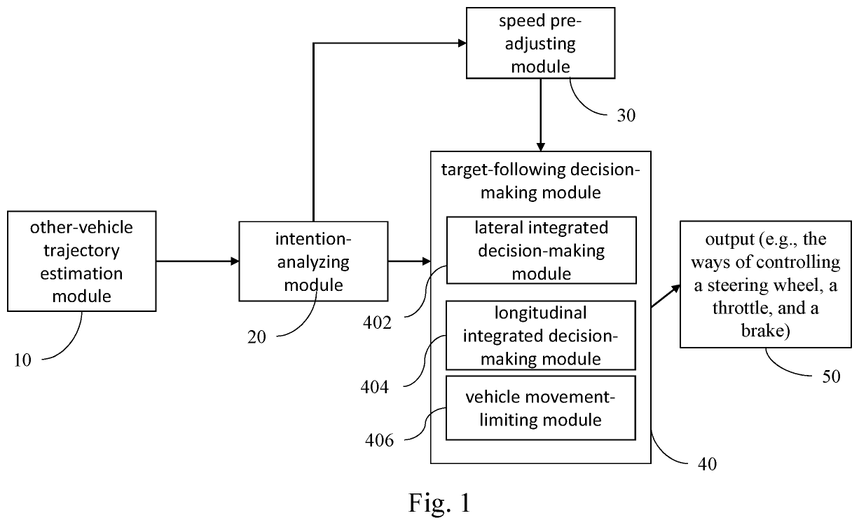

The present invention provides an active safety assistance system for pre-adjusting speed and a control method using the same. Refer to FIG. 1. FIG. 1 is a diagram illustrating an active safety assistance system for pre-adjusting speed according to an embodiment of the present invention. The active safety assistance system comprises an other-vehicle trajectory estimation module 10, an intention-analyzing module 20, a speed pre-adjusting module 30, and a target-following decision-making module 40. When detecting a front vehicle or neighboring vehicles in left and right lanes, the other-vehicle trajectory estimation module 10 calculates the deviation amount of the host vehicle with respect to a lane center according to a plurality of environment-sensing data and estimates the other-vehicle trajectory of at least one other vehicle that neighbors the host vehicle. The trajectory is defined as a combinatorial function composed of a position and a speed at every estimated unit time point. Thus, the other-vehicle trajectory includes a future path and a future speed. In such a case, the plurality of environment-sensing data comprises the vehicle-width recognition result and the related information (e.g., the longitudinal and lateral relative speeds and the longitudinal and lateral relative distances) of the other vehicle, the moving-state information (e.g., the dynamic trajectory) of the host vehicle, a lane line-detecting result, and a lane-line model. These environment-sensing data are obtained by the conventional sensing recognition technology. Thus, the present invention does not describe how to obtain the environment-sensing data. The intention-analyzing module 20 is coupled to the other-vehicle trajectory estimation module 10 and configured to fit the other-vehicle trajectory to at least one lane to determine that the other vehicle intends to advance in the same lane, turn in the same lane or switch over to another lane (e.g., a neighboring vehicle switching over to a lane where the host vehicle drives or a front vehicle switching over from a lane where the host vehicle drives to another lane), and fit the other-vehicle trajectory to the dynamic trajectory of the host vehicle to generate a fitted result. If there are many other vehicles, the intention-analyzing module 20 determines whether the other vehicle is used as at least one target vehicle that influences the movement of the host vehicle according to the fitted result and the intention of the other vehicle. If all the other vehicles do not influence the movement of the host vehicle, the target vehicle does not exist. The intention-analyzing module 20 calculates at least one control parameter for fixing distance, fixing speed, or pre-adjusting speed of the host vehicle when the target vehicle exists. The speed pre-adjusting 30 is coupled to the intention-analyzing module 20 and configured to receive the control parameter and use the control parameter to cooperate with the deviation amount, a speed, a lateral acceleration, and a plurality of state data of the host vehicle to calculate a target speed of the host vehicle that a driver feels comfortable. The target-following decision-making module 40 comprises a lateral integrated decision-making module 402, a longitudinal integrated decision-making module 404, and a vehicle movement-limiting module 406. The lateral integrated decision-making module 402 is configured to control a steering wheel, and the longitudinal integrated decision-making module 404 is configured to control a throttle pedal and a brake force. The target-following decision-making module 40, coupled to the intention-analyzing module 20 and the speed pre-adjusting module 30, makes decisions for the steering wheel, the throttle pedal, and the brake force in lateral and longitudinal directions according to the intention of the target vehicle and the trajectory, the control parameter, and the target speed of the host vehicle, and the decisions made by the target-following decision-making module 40 are used as an output 50. The operation of each module is described as follows in detail.

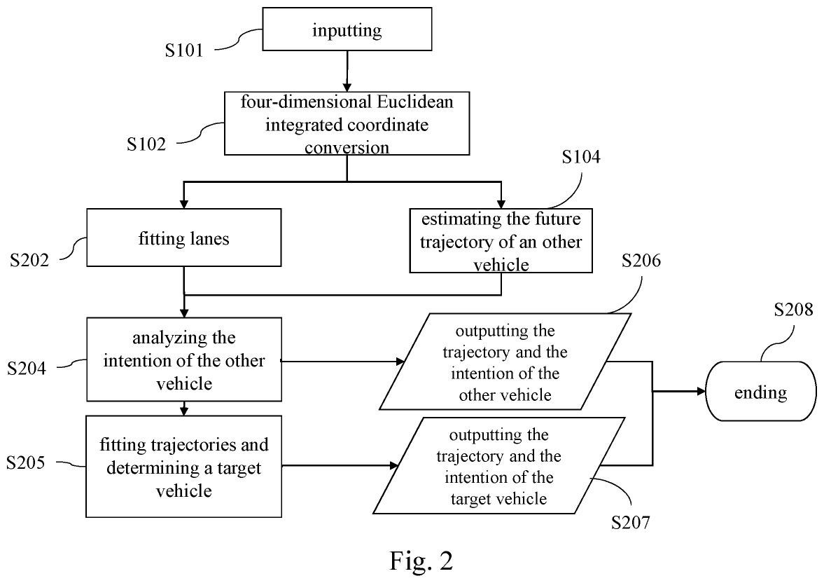

FIG. 2 is a flowchart of an operation process of the other-vehicle trajectory estimation module 10 and the intention-analyzing module 20 in FIG. 1 according to an embodiment of the present invention. In Step S101, the environment-sensing data including the result of detecting the lane line, the vehicle width-recognizing result of the other vehicle, the other-vehicle information (e.g., the longitudinal and lateral relative speeds and the longitudinal and lateral relative distances), and the dynamic trajectory of the host vehicle are inputted. In Step S102, the other-vehicle trajectory estimation module 10 substitutes the plurality of environment-sensing data into the four-dimensional Euclidean coordinate transforming formula and combines time and space, as shown by the following formula (1):

vₖ=Tₖ(uₖ),k∈L,F,M (1)

T_{L}, T_{F}, and T_{M} respectively represent a lane line, fusion information (as the other-vehicle information), and the dynamic trajectory of the host vehicle coordinate transforming function from their own space to the host vehicle space. u_{L}, u_{F}, and u_{M} respectively represent a lane line, fusion information (as the other-vehicle information), and the dynamic-trajectory information (including time) of the host vehicle in their own space. v_{L}, v_{F}, and v_{M} are respectively a lane line, fusion information (as the other-vehicle information), and the dynamic-trajectory information of the host vehicle in the host vehicle-coordinate system.

In Step S104, the other-vehicle trajectory estimation module 10 uses a representative formula of

$${P}_{i} ( t ) = {min}_{P} ( Σ ‖ P ( {t}^{-} ) - {x}_{i , {t}^{-}} ‖ )$$

to obtain the future trajectory of the front vehicle, wherein x_{i,t} represents the other-vehicle information of the i-th front vehicle at previous time t⁻ and P(t) is a quadratic function of time t. The representative formula is used to calculate the optimal moving-trajectory function of the other vehicle. As a result, the other-vehicle trajectory estimation module 10 outputs the future trajectory of the other vehicle.

The vehicle-coordinate system in Step S102 is used for fitting a lane in Step S202. After the other-vehicle trajectory estimation module 10 combines time and space according to formula (1), the process proceeds to Step S202. In Step S202, the intention-analyzing module 20 cooperates with formula (1) to determine that the other vehicle drives at the inside of a lane where the host vehicle presently drives, the left of the outside of a lane where the host vehicle presently drives, or the right of the outside of a lane where the host vehicle presently drives, thereby performing a lane-fitting process. L_{L} and L_{R} ∈=v_{L} respectively represent functions of left and right lane lines and x_{i,0} represents the position of the i-th other vehicle. According to formula (2), the present invention determines that the other vehicle drives at the inside of a lane where the host vehicle presently drives, the left of the outside of a lane where the host vehicle presently drives, or the right of the outside of a lane where the host vehicle presently drives.

L_{L}(x_{l,0})≥0&L_{R}(x_{l,0})≥0 (2)

After obtaining the information according to formulas (1) and (2), the intention of the other vehicle is analyzed according to formula (3) in Step S204.

L_{L}(x_{i,t}_{⁺})≥0&L_{R}(x_{i,t}_{⁺}) (3)

Formula (3) substitutes future time t⁺ into the moving-trajectory function Pᵢ to calculate the future moving-trajectory x_{i,t}+=Pₗ(t⁺) of the i-th other vehicle. Using the functions of left and right lane lines L_{L} and L_{R}, formula (3) determines that the i-th other vehicle will advance in the same lane, turn in the same lane, switch over to a lane where the host vehicle drives, or switch over from a lane where the host vehicle drives to another lane. Thus, in Step S206, the intention and the trajectory of the other vehicle are outputted. In addition, the intention and the trajectory of the other vehicle are obtained in Step S204. However, there may be many other vehicles. Thus, in Step S205, the trajectories of the host vehicle and the other vehicles are fitted to each other step by step. According to the trajectory Mₜ₊∈v_{M} of the host vehicle based on future time t⁺ and the trajectory x_{i,1+} of the other vehicle, the other vehicle that may collide with the host vehicle in the future is used as a target vehicle. For example, a neighboring vehicle that will switch over to a lane where the host vehicle drives is used as the target vehicle. Afterwards, in Step S207, the intention and the trajectory of the target vehicle are outputted. In Step S208, the operation process of the intention-analyzing module 20 is ended. If the fitted results represent that all the other vehicles do not influence the movement of the host vehicle, the target vehicle does not exist. Besides, the at least one control parameter of the host vehicle calculated by the intention-analyzing module 20 is also the control parameter of the speed pre-adjusting module 30. Since the trajectory includes positions and speeds, the moving position and the speed thereof of the front vehicle or the target vehicle are obtained after obtaining the trajectory and the intention of the front vehicle or the target vehicle through the operation process of FIG. 2, wherein the moving position and the speed thereof of the front vehicle or the target vehicle are used as the control parameter of the speed pre-adjusting module 30.

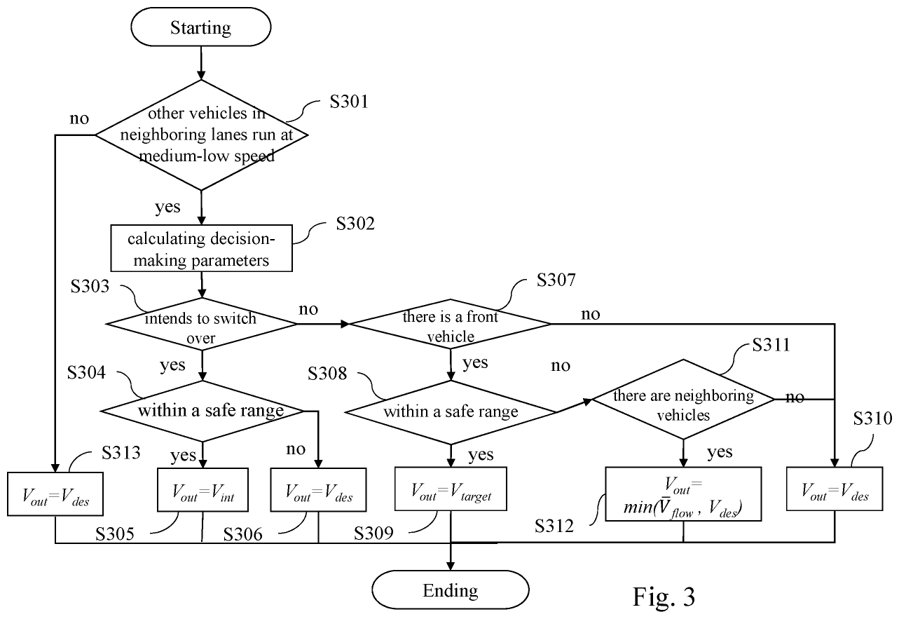

FIG. 3 is a flowchart of an operation process of the speed pre-adjusting module 30 in FIG. 1 according to an embodiment of the present invention. A distance between two vehicles driving at medium-low speed is shorter than a distance between two vehicles driving at high speed. In order to avoid the related control problem caused by the shorter distance between two vehicles, such as unstably detecting images or frequently braking, the speed pre-adjusting module 30 starts when other vehicles in neighboring lanes run at medium-low speed. Thus, in Step S301, the process determines whether other vehicles in neighboring lanes run at medium-low speed, such as less than 40 kilometers per hour. If the answer is no, the process proceeds to Step 313. In Step S313, the vehicle speed set by the driver is directly used as a target speed V_{des}. If the answer is yes, the process proceeds to Step 302. In Step S302, a plurality of decision-making parameters are calculated, including those of the target speed V_{des}, a comfortable speed V_{cft}, the minimum vehicle speed Vₗᵢₘᵢₜ, a safe distance D_{safe}, and the average speed V_{flow} of vehicles driving in neighboring lanes. Limited by a lateral acceleration, the maximum driving speed is the comfortable speed V_{cft}. For example, when passing through a curve with a radius of curvature of 250 m and limiting a lateral acceleration to 0.1 g, the comfortable speed V_{cft} is obtained. The target speed V_{des} is expressed as follows:

$${V}_{des} = \{ \begin{matrix}{V}_{set} , if {V}_{set} < {V}_{cft} \\ {V}_{cft} , if {V}_{cft} \leq {V}_{set} \\ {V}_{limit} , if {V}_{limit} < ( {V}_{set} \vert \vert {V}_{cft} )\end{matrix} \qquad ( 4 )$$

Vₛₑₜ represents a cruising-vehicle speed (kph) set by the driver, V_{cft}=\sqrt{a_{y,limit}*R}, R represents the radius (m) of curvature, and a_{y,limit} represents a limited lateral acceleration (m/s²).

$${V}_{limit} = \sqrt{\frac{g}{k} * \frac{sin θ + μ * cos θ}{cos θ - μ * sin θ}} ,$$

wherein θ represents the inclined angle of a road, k represents the curvature of a road, g represents the gravity acceleration, and μ represents the longitudinal friction coefficient. V_{flow}=max(V̅_{L},V̅_{R}), wherein V̅_{L} represents the average speed of vehicles driving in a left lane, and V̅_{R} represents the average speed of vehicles driving in a right lane. D_{safe}=HWT×Vₕₒₛₜ, wherein HWT represents a time headway, Vₕₒₛₜ represents the speed of the host vehicle, and Vᵢₙₜ represents the estimated future speed of the other vehicle.

In Step S303, the process determines whether one (e.g., the target vehicle) of neighboring vehicles in left and right neighboring lanes intends to switch over to a lane where the host vehicle drives. If the answer is yes, the process proceeds to Step S304. In Step S304, the process determines whether a distance between the neighboring vehicle and the host vehicle is within a safe range, such as within 2 meters. If the answer is yes, the process proceeds to Step S305. In Step S305, the output vehicle speed Vₒᵤₜ is set to the future vehicle speed Vᵢₙₜ of the neighboring vehicle estimated by the other-vehicle trajectory estimation module 10. If the answer is no, the process proceeds to Step S306. In Step S306, the output vehicle speed Vₒᵤₜ is directly used as the target speed V_{des} and the target speed V_{des} is determined according to formula (4). When the process determines that one of neighboring vehicles in left and right neighboring lanes does not intend to switch over to a lane where the host vehicle drives in Step S303, the process proceeds to Step S307. In Step S307, the process determines whether there is a front vehicle. If the answer is no, the process proceeds to Step S310. In Step S310, the output vehicle speed Vₒᵤₜ is directly used as the target speed V_{des} and the target speed V_{des} is determined according to formula (4). If the answer is yes, the process proceeds to Step S308. In Step S308, the process determines whether a distance between the front vehicle and the host vehicle is within a safe range. If the answer is yes, the process proceeds to Step S309. In Step S309, the output vehicle speed Vₒᵤₜ is the speed V_{target} of the target vehicle determined by the intention-analyzing module 20. That is to say, the output vehicle speed Vₒᵤₜ is equal to the speed of the front vehicle. If the distance between the front vehicle and the host vehicle is not within the safe range, the host vehicle needs to decelerate or avoid collisions. Thus, the process needs to determine whether neighboring vehicles drive in left and right neighboring lanes. In Step S311, the process proceeds to Step S312 when the neighboring vehicles drive in left and right neighboring lanes. In Step S312, the process compares a higher one of the average speeds of the vehicles driving in left and right lanes with the target speed V_{des} [determined by formula (4)] to obtain a lower one of the higher one and the target speed V_{des}. The process proceeds to Step S310 when the neighboring vehicles do not drive in left and right neighboring lanes. In Step S310, the output vehicle speed Vₒᵤₜ is directly used as the target speed V_{des} and the target speed V_{des} is determined according to formula (4). This way, the speed pre-adjusting module 30 calculates and obtains the target speed V_{des} as a comfortable speed V_{cft} that the driver feels comfortable according to the vehicle-following distance that the host vehicle follows the other vehicle, the average speed of vehicles driving in neighboring lanes, the road curvature, the speed and the limited lateral acceleration of the host vehicle, and the intention of the other vehicle determined by the intention-analyzing module 20.

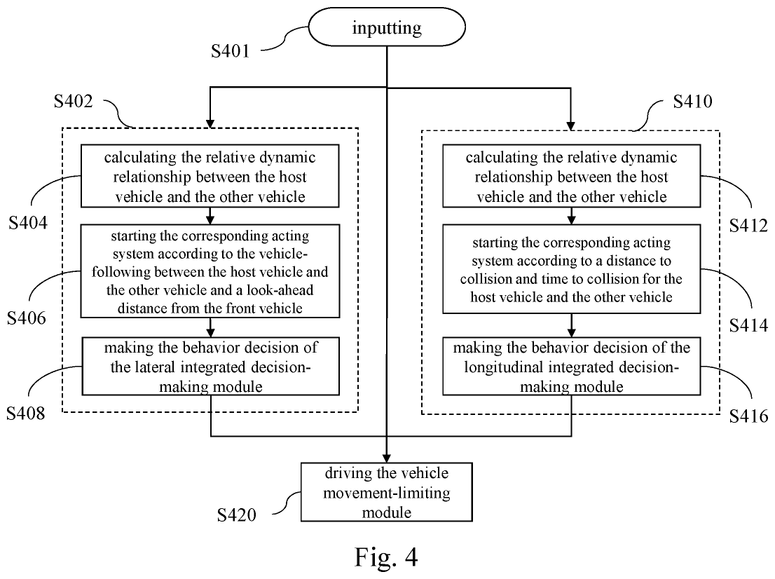

FIG. 4 is a flowchart of an operation process of the target-following decision-making module 40 in FIG. 1 according to an embodiment of the present invention. The required information, including those of the dynamic trajectory and the intention (e.g., advancing in the same lane, turning in the same lane, switching over from a lane where the host vehicle drives to another lane, or switching over to another lane) of the other vehicle (e.g., the front vehicle and neighboring vehicles in left and right neighboring lanes), the dynamic trajectory, the yaw rate, and the acceleration of the host vehicle, the output (e.g., the intentions and the trajectories of the target vehicle and the other vehicle) of Step S208 in FIG. 2, and the outputted target speed in FIG. 3, is inputted. Then, the process proceeds to Step S402 for a lateral integrated decision and Step S410 for a longitudinal integrated decision, respectively. Step S402 comprises Step S404, Step S406, and Step S408. In Step S404, the relative dynamic relationship between the host vehicle and the other vehicle is calculated. In Step S406, the corresponding acting system is started according to the vehicle-following between the host vehicle and the other vehicle and a look-ahead distance from the front vehicle. In an embodiment of the present invention, the acting systems include a lane following system (LFS) and a car following system (CFS) in the lateral integrated decision. In Step S408, the behavior decision of the lateral integrated decision-making module 402 is made, such as a steering-wheel angle and a turning angle. Step S410 comprises Step S412, Step S414, and Step S416. In Step S412, the relative dynamic relationship between the host vehicle and the other vehicle is calculated. In Step S414, the corresponding acting system is started according to a distance to collision and time to collision for the host vehicle and the other vehicle. In an embodiment of the present invention, the acting systems of the longitudinal integrated decision-making module 404 include an adaptive cruise control (ACC) system and an autonomous emergency braking (AEB) system. In Step S416, the behavior decision of the longitudinal integrated decision-making module 404 is made, such as controlling braking force and a throttle pedal. The target-following decision-making module 40 performs Step S420. In Step S420, the vehicle movement-limiting module 406 receives the inputted information in Step S401 and the outputted behavior decisions in Steps S402 and S410 to calculate a steering-wheel angle for longitudinal limitation and lateral limitation, thereby avoiding a vehicle overturn event in passing through a curve at unsuitable speed or avoiding a vehicle overturn event and the driver's uncomfortable feeling when the variation of the steering-wheel angle is too large in driving the vehicle.

Furthermore, the vehicle movement-limiting module 406 calculates a vehicle speed for longitudinal limitation in order to obtain an ideal vehicle speed in passing through a curve. The vehicle movement-limiting module 406 calculates a steering-wheel angle for lateral limitation in order to avoid the great variation of the steering-wheel angle. The formula (5) of calculating the ideal vehicle speed is expressed as follows:

$$V \leq \sqrt{\frac{g}{k} \cdot \frac{sin θ + μ \cdot cos θ}{cos θ - μ \cdot sin θ}} = {V}_{max} , {a}_{max} = \sqrt{\frac{{v}^{2} - {v}_{max}^{2}}{2 ( d - {t}_{r} v )}} \qquad ( 5 )$$

Wherein, θ represents the inclined angle of a road, k represents the curvature of a road, g represents the gravity acceleration, μ represents the longitudinal friction coefficient, a represents an acceleration, d represents a safe distance, tᵣ represents response time, and V represents a longitudinal vehicle speed. If θ=0, cos θ≈0 and sin θ═0,

$${V}_{max} = \sqrt{\frac{g}{k} ( \frac{θ + μ}{1 - μθ} )} ,$$

which is the maximum vehicle speed in passing through a curve, namely the ideal vehicle speed.

In order to calculate the steering-wheel angle for lateral limitation, the sideslip angle βᵥ=tan⁻¹(V_{y}/Vₓ) of a vehicle body is calculated. Then, the error βₑ=sin⁻¹(lᵣ·k_{c})−βᵥ of the sideslip angle is calculated. The limited steering angle

$${δ}_{f \_ lim} = {tan}^{-} \{ \frac{{l}_{f} + {l}_{r}}{{l}_{r}} \cdot tan ( β e ) \}$$

of a front wheel is calculated by limiting the error of the sideslip angle. Finally, the steering angle of the front wheel is multiplied by a gear ratio to obtain the limited steering-wheel angle. Wherein, βᵥ represents the sideslip angle of the vehicle body, δ_{f} represents the steering angle of the front wheel, l_{f} represents a wheelbase between the center of gravity of a vehicle and a front wheel, lᵣ represents a wheelbase between the center of gravity of a vehicle and a back wheel, βₑ represents the error of the sideslip angle, V_{y} represents the lateral speed of the host vehicle, and Vₓ represents the longitudinal speed of the host vehicle.

In the lateral integrated decision, the process determines whether the front vehicle influences lane-line detection. When following a vehicle at low speed and a distance between two vehicles is shorter, the front vehicle influences lane-line detection such that lane lines are shielded or unstably detected. When the front vehicle influences lane-line detection, the lateral integrated decision makes a decision for using the CFS to follow the front vehicle and correspondingly adjust the steering-wheel angle. Accordingly, the lateral integrated decision performs vehicle-width recognition on the front vehicle, such that the host vehicle follows the middle of the width of the front vehicle. If the front vehicle does not influence lane-line detection, the LFS is performed such that the host vehicle drives at the center of the lane and maintains uniform distances from left and right lane lines. In addition, the lateral integrated decision determines the movement (e.g., advancing in the same lane, turning in the same lane, or switching over to another lane) of the front vehicle to makes a correct lateral decision according to the estimated intention and trajectory of the other vehicle. For example, the moving trajectories of a vehicle in turning and switching over to another lane are similar. If the lateral integrated decision makes a decision for following the front vehicle, the host vehicle switches over to another lane when the front vehicle switches over to another lane. As a result, the lateral integrated decision performs a lane-center control mode or an out-of-control mode (i.e., the control of the host vehicle is returned to the driver without using lateral control since lane lines are not recognized) instead of performing a vehicle-following control mode, lest the host vehicle and the front vehicle simultaneously switch over to another lane.

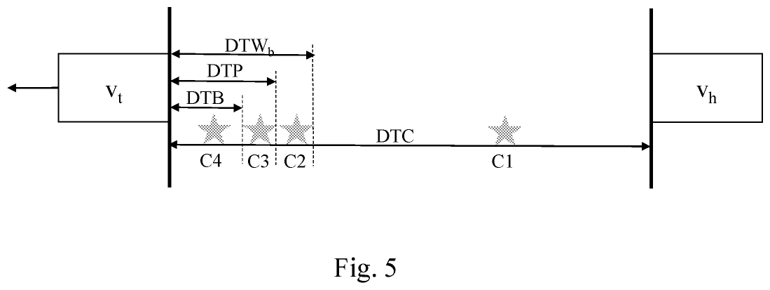

FIG. 5 is a diagram illustrating a distance to collision between a host vehicle and a front vehicle according to an embodiment of the present invention. vₕ represents the speed of the host vehicle and vₜ represents the speed of the target vehicle. The reference to calculate distance is based on the Vt-coordinate. Radars detect a distance between the host vehicle point (C1) and the front vehicle and this distance is also called DTC (distance to collision). A distance between a collision point C2 and the target vehicle is expressed by

$${DTW}_{b} = [ ( {v}_{h} - {v}_{t} ) ( {t}_{r} + 2 ) ] + \frac{{v}_{h}^{2} - {v}_{t}^{2}}{2 μ g} + {d}_{min} .$$

A distance between a collision point C3 and the target vehicle is expressed by

$$DTP = [ ( {v}_{h} - {v}_{t} ) ( {t}_{r} + 1 ) ] + \frac{{v}_{h}^{2} - {v}_{t}^{2}}{2 μ g} + {d}_{min} .$$

A distance between a collision point C4 and the front vehicle is expressed by

$$DTB = ( {v}_{h} - {v}_{t} ) {t}_{r} + \frac{{v}_{h}^{2} - {v}_{t}^{2}}{2 μ g} + {d}_{min} .$$

For dangerous levels, C4>C3>C2>C1. If vₕ is larger than vₜ,

$$TTC = \frac{DTC}{{v}_{r}} = \frac{DTC}{{v}_{h} - {v}_{t}}$$

represents time to collision. The time to collision represents how much time the host vehicle will collide with the front vehicle.

$${TTC}^{′} \approx \frac{Δ TTC}{Δ t} = \frac{{TTC}_{k} - {TTC}_{k - 1}}{{t}_{k} - {t}_{k - 1}}$$

represents average time to collision. tᵣ represents response time, typically 0.8˜1.2 seconds. dₘᵢₙ represents a static distance, such as 2 meters. μ represents the friction coefficient, typically 0.7˜0.8. g represents gravity.

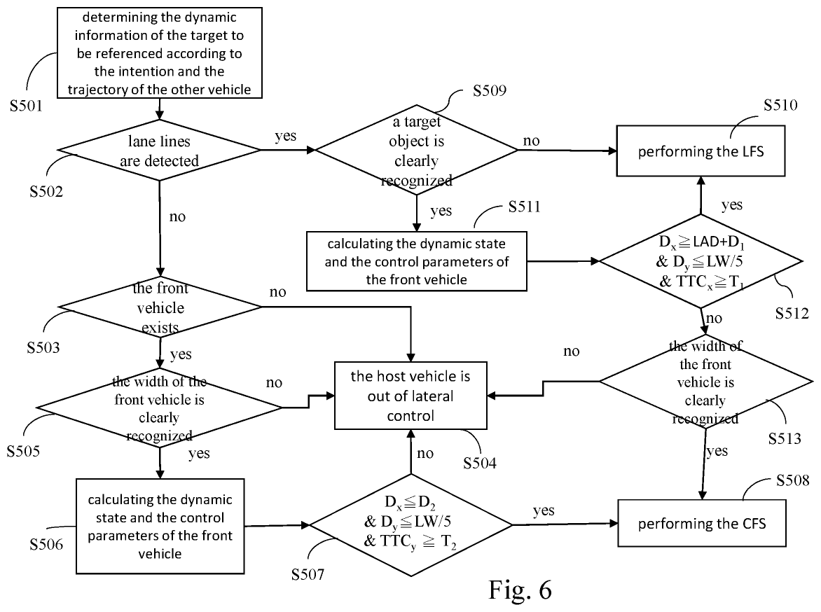

FIG. 6 is a flowchart of an operation process of the lateral integrated decision of Step S402 in FIG. 4 (corresponding to the lateral integrated decision-making module 402 in FIG. 1) according to an embodiment of the present invention. Refer to FIG. 6. Firstly, in Step S501, the dynamic information of the target to be referenced is determined according to the intention and the trajectory of the other vehicle. The dynamic information includes distances Dₓ and D_{y} from a target vehicle and the speeds Vₓ and V_{y} of the target vehicle. In Step S502, the process determines whether lane lines are detected. If the lane lines fail to be detected, the process proceeds to Step S503. In Step S503, the process determines whether the front vehicle exists. The front vehicle does not exist, which represents that the environment-sensing technology fails to provide the target to be referenced such that the lateral integrated decision is not made. In such a case, the process proceeds to Step S504. In Step S504, the host vehicle is out of lateral control. If the front vehicle exists, the process proceeds to Step S505. In Step S505, the process determines whether the width of the front vehicle is clearly recognized, such that the host vehicle aims at the middle of the width of the front vehicle and follows the front vehicle. If the width of the front vehicle is not clearly recognized, the process proceeds to Step S504. In Step S504, the host vehicle is out of lateral control. If the width of the front vehicle is clearly recognized, the process proceeds to Step S506. In Step S506, the dynamic state and the control parameters of the front vehicle are calculated, including those of a distance DTC (distance to collision) from the front vehicle detected by radars, a look-ahead distance LAD, a distance to warning DTW, a distance to braking DTB, and time to collision TTC. Then, the process proceeds to Step S507. In Step S507, the process determines whether Dₓ≤D₂, D_{y}≤LW/5, and TTC_{y}≥T₂. D₂ represents a distance-controlling parameter associated with perception errors and delay time of actuators and used to avoid a great distance and the great error of a vehicle width. LW represents a lane width (m). TTC_{y} represents time to lateral collision, which is equal to a relative lateral distance D_{ry} divided by a relative longitudinal speed V_{ry}. T represents a time-controlling parameter associated with the laterally-moving speed of the front vehicle as the target. The larger T represents that the front vehicle slowly moves in a lateral direction. If Dₓ≤D₂, D_{y}≤LW/5, and TTC_{y}≥T₂, the process proceeds to Step S508. In Step S508, the CFS is performed. The process returns to Step S502. If single-sided or double-sided lane lines are detected, the process proceeds to Step S509. In Step S509, the process determines whether a target object (e.g., the front vehicle) is clearly recognized. If the target object is unstably recognized or the target object does not exist, the process proceeds to Step S510. In Step S510, the LFS is performed. If the target object is stably recognized or the target object exists, the process proceeds to Step S511. In Step S511, the dynamic state and the control parameters of the front vehicle are calculated, including those of DTC, LAD, DTW, DTB, and TTC. Step S511 is the same to Step S506. Then, in Step S512, the process determines whether Dₓ>LAD+D₁, D_{y}≤LW/5, and TTCₓ≥T₁. LAD represents a look-ahead distance and LAD=c*Vₕ+d. TTCₓ represents longitudinal time to collision. Vₕ represents the speed of the host vehicle, c represents a preview ratio, d represents a distance from the dead zone of an image, and D₁ represents a distance-controlling parameter associated with perception errors and delay time of actuators and used to prevent the front vehicle from influencing the precision of detecting lane lines within LAD. If Dₓ≥LAD+D₁, D_{y}≤LW/5, and TTCₓ≥T₁, the process proceeds to Step S510. In Step S510, the LFS is performed. If a distance between two vehicles is too short such that lane lines are unstably detected, the process proceeds to Step S513. In Step S513, the process determines whether the width of the front vehicle is clearly recognized. If the answer is yes, the process proceeds to Step S508. In Step S508, the CFS is performed. If the answer is no, the process proceeds to Step S504. In Step S504, the host vehicle is out of lateral control.

The longitudinal integrated decision of Step S410 in FIG. 4 (corresponding to the longitudinal integrated decision-making module 404 in FIG. 1) determines how much time (e.g., time to collision) the host vehicle will collide with the front vehicle at the current speed. Statically, the most appropriate time to deceleration or lane change that a driver needs lasts for 4˜6 seconds. When the time to deceleration or lane change is less than 3 seconds, the driver feels nervous and responds too late such that traffic accidents occur. Consequently, the longitudinal integrated decision starts the ACC system or the AEB system or outputs a collision warning according to the speeds of the host vehicle and the front vehicle, the distance to collision between the host vehicle and the front vehicle, the system response time (e.g., 0.8˜1.2 seconds), a distance to stop (e.g., 2 meters) that the host vehicle needs to stop from the target vehicle, the friction coefficient (typically 0.7˜0.8), and the acceleration of gravity.

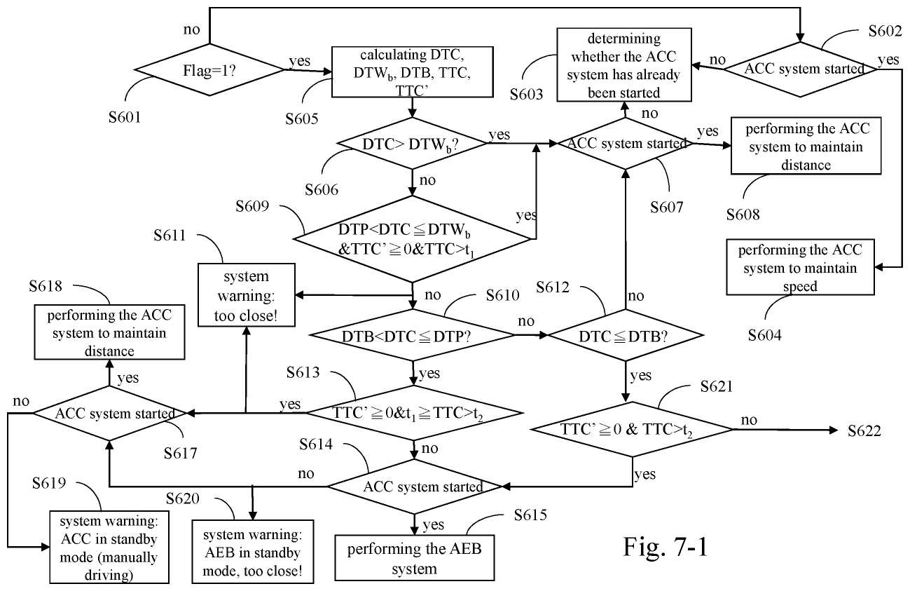

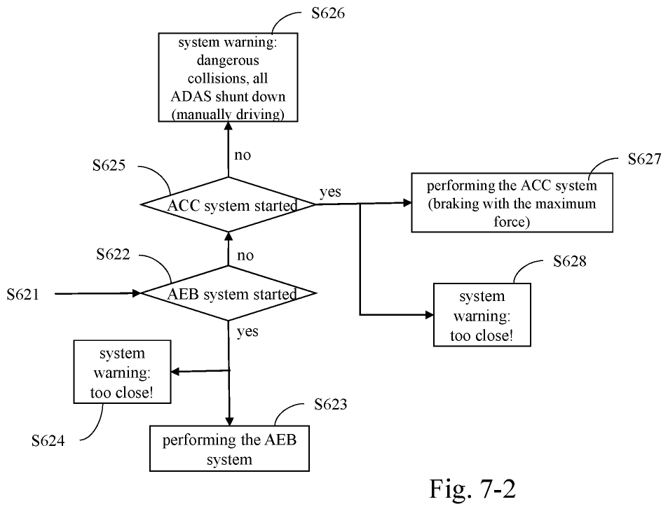

FIG. 7 is a flowchart of an operation process of the longitudinal integrated decision-making module 404 in FIG. 1 according to an embodiment of the present invention. Firstly, in Step S601, the process determines whether Flag is 1. Flag is used to determine whether a target appears at the front. Flag=1 represents that a target vehicle exists. Flag=0 represents that the target vehicle does not exist. In other words, there is no vehicle at the front or the estimated trajectories of neighboring vehicles do not influence the host vehicle. In Step S602, the process determines whether the ACC system has already been started if Flag=0. If the answer is yes, the process proceeds to Step S604. In Step S604, the ACC system is performed to maintain speed. If the answer is no, the host vehicle is driven by a driver, not by a driver assistance system. In Step S603, the user interface of the on-board system displays “ACC in standby mode”. When Flag=1, which represents the target exists at the front, the process proceeds to Step S605. In Step S605, DTC, DTW_{b}, DTB, TTC, and TTC′ are calculated, wherein TTC′ is the differential of TTC. Then, in Step S606, the process determines whether DTC is larger than DTW_{b}. If the answer is yes, the process proceeds to Step S607. In Step S607, the process determines whether the ACC system has already been started. If the answer is yes, the process proceeds to Step S608. In Step S608, the ACC system is performed to maintain a safe distance from the front vehicle. If the answer is no, the host vehicle is driven by a driver, not by a driver assistance system. Thus, the process proceeds to Step S603. In Step S603, the user interface of the on-board system displays “ACC in standby mode”. The process returns to Step S606. If DTC<DTW_{b}, the process proceeds to Step S609. In Step S609, the process determines whether DTP<DTC≤DTW_{b}, TTC′≥0, and TTC>t₁. If the answer is yes, the process proceeds to Step S607. In Step S607, the process determines whether the ACC system has already been started. If the answer is no, the process proceeds to Step S610 and Step S611, respectively. In Step S611, the system outputs a warning that the host vehicle is too close to the front vehicle. In Step S610, the process determines whether DTB<DTC≤DTP. If the answer is no, the process proceeds to Step S612. In Step S612, the process determines whether DTC≤DTB. If the answer is no, the process returns to Step S607. The answer is yes in Step S612, which represents the host vehicle is too close to the front vehicle. Thus, the process proceeds to Step S621. In Step S621, the process determines whether TTC′≥0 and TTC>t₂. If the answer is yes, the process proceeds to Step S614. In Step S614, the process determines whether the AEB system has already been started. If the answer is yes, the process proceeds to Step S615. In Step S615, the AEB system is performed. If the answer is no, the process proceeds to Step S617 and Step S620, respectively. In Step S620, a system warning is outputted to remind the driver of “AEB system in standby mode” and remind the driver that the host vehicle is too close to the front vehicle. In Step S617, the process determines whether the ACC system has already been started. If the answer is yes, the process proceeds to Step S618. In Step S618, the ACC system is performed to maintain a safe distance from the front vehicle. If the answer is no, the host vehicle is driven by a driver, not by a driver assistance system. Thus, the process proceeds to Step S619. In Step S619, the user interface of the on-board system displays “ACC in standby mode”.

If the answer is yes in Step S610, the process proceeds to Step S613. In Step S613, the process determines whether TTC′≥0 and t₁≥TTC>t₂. If the answer is no, the process proceeds to Step S614. In Step S614, the process determines whether the AEB system has already been started. The following process is described as mentioned. If the answer is yes in Step S613, the process proceeds to Step S617 and Step S611 without performing Step S614. In Step S617, the process determines whether the ACC system has already been started. In Step S611, a system warning is outputted to remind the driver that the host vehicle is too close to the front vehicle. The following process is also described as mentioned.

If the answer is no in Step S621, the process proceeds to Step S622. In Step S622, the process determines whether the AEB system has already been started. If the answer is yes, the process proceeds to Step S624 and Step S623, respectively. In Step S624, a system warning is outputted to remind the driver that the host vehicle is too close to the front vehicle. In Step S623, the AEB system is performed to decelerate. If the answer is no in Step S622, the process proceeds to Step S625, In Step S625, the process determines whether the ACC system has already been started. If the answer is yes, the process proceeds to Step S627 and Step S628, respectively. In Step S627, the ACC system is performed to brake with the maximum force. In Step S628, a system warning is outputted to remind the driver that the host vehicle is too close to the front vehicle. If the answer is no, the process proceeds to Step S626. In such a case, the distance between the host vehicle and the front vehicle is less than the safe distance, the acting time (t₂−t₁) is not reserved, and the AEB system and the ACC system do not start. Thus, the host vehicle is driven by the driver. Accordingly, in Step S626, the system outputs a warning to remind the driver that a dangerous collision will occurs and all advanced driver assistance systems (ADAS) shunt down.

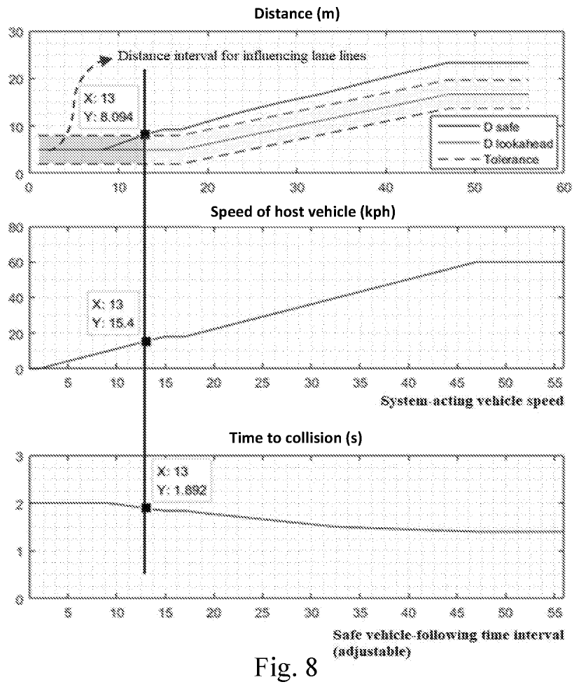

FIG. 8 is a diagram schematically illustrating a safe vehicle-following distance for longitudinal control, a preview distance for lateral control, and a safe vehicle-following time interval according to an embodiment of the present invention. When the host vehicle follows the vehicle at speed of 15 kilometers per hour (kph), the safe vehicle-following distance is 8 m and the time to collision or the vehicle-following time interval is 1.89 seconds. The result represents that the distance between the two vehicles is too short to detect lane lines (D_{lookahead} must be shorter than D_{safe}), thereby setting the control parameters in FIG. 6.

In conclusion, the active safety assistance system for pre-adjusting speed and the control method using the same of the present invention, applied to the on-board system of the host vehicle, detect the future trajectories and speeds of the other vehicles at the front and in left and right neighboring lanes in driving, fit the future trajectories of the other vehicles to the future trajectory of the host vehicle, analyze the intention (e.g., advancing in the lane, turning in the same lane, or switching over to another lane) of the other vehicle to determine whether the invention influences the movement of the host vehicle, determine how to control the lateral and longitudinal movement of the host vehicle, pre-adjust the vehicle speed to a target value that the driver feels comfortable during the overall control process, and cooperate with the driver assistance system to maintain a safe distance from the other vehicle, thereby avoiding collisions.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An active safety assistance system for pre-adjusting speed, installed on an on-board system of a host vehicle, comprising:
an other-vehicle trajectory estimation module configured to calculate a deviation amount of the host vehicle with respect to a lane center according to a plurality of environment-sensing data and estimate an other-vehicle trajectory of at least one other vehicle when the other-vehicle trajectory estimation module detects the at least one other vehicle around the host vehicle;
an intention-analyzing module coupled to the other-vehicle trajectory estimation module and configured to fit the other-vehicle trajectory to at least one lane to determine that the at least one other vehicle intends to advance in a same lane, turn in a same lane or switch over to another lane, fit the other-vehicle trajectory to a dynamic trajectory of the host vehicle to generate a fitted result, and determine whether the at least one other vehicle is used as at least one target vehicle that influences movement of the host vehicle according to the fitted result and an intention of the at least one other vehicle, and the intention-analyzing module calculates at least one control parameter for fixing distance, fixing speed, or pre-adjusting speed of the host vehicle when the at least one target vehicle exists;
a speed pre-adjusting module coupled to the intention-analyzing module and configured to receive the at least one control parameter and use the at least one control parameter to cooperate with the deviation amount, a speed, a lateral acceleration, and a plurality of state data of the host vehicle to calculate a target speed of the host vehicle; and
a target-following decision-making module coupled to the intention-analyzing module and the speed pre-adjusting module and configured to make decisions for a steering wheel, a throttle pedal and a brake force of the host vehicle according to an intention of the at least one target vehicle, the dynamic trajectory, the at least one control parameter, and the target speed.

2. The active safety assistance system for pre-adjusting speed according to claim 1, wherein the at least one other vehicle comprises a front vehicle and neighboring vehicles in left and right lanes.

3. The active safety assistance system for pre-adjusting speed according to claim 1, wherein the plurality of environment-sensing data comprise a vehicle-width recognition result, longitudinal and lateral relative speeds, and a relative distance of the at least one other vehicle, moving-state information of the host vehicle, a lane line-detecting result, and a lane-line model.

4. The active safety assistance system for pre-adjusting speed according to claim 3, wherein the other-vehicle trajectory estimation module substitutes the plurality of environment-sensing data into a four-dimensional Euclidean coordinate transforming formula, combines time and space, and uses a representative formula of
$${P}_{i} ( t ) = {min}_{P} ( Σ ‖ P ( {t}^{-} ) - {x}_{i , {t}^{-}} ‖ )$$
to obtain a future trajectory of the at least one other vehicle, wherein x_{i,t} represents other-vehicle information of an i-th other vehicle at previous time t⁻ and P(t) is a quadratic function of time t.

5. The active safety assistance system for pre-adjusting speed according to claim 3, wherein the other-vehicle trajectory estimation module combines time and space to generate a combined result, and the intention-analyzing module uses the combined result to determine that the at least one other vehicle drives at an inside of a lane where the host vehicle presently drives, left of an outside of a lane where the host vehicle presently drives, or right of an outside of a lane where the host vehicle presently drives, thereby performing a lane-fitting process.

6. The active safety assistance system for pre-adjusting speed according to claim 1, wherein the plurality of state data comprise a vehicle-following distance that the host vehicle follows the at least one other vehicle, an average speed of vehicles driving in neighboring lanes, and a road curvature, the speed pre-adjusting module determines whether a distance between the host vehicle and the at least one other vehicle is within a safe range to adjust the speed of the host vehicle and obtain the target speed according to the vehicle-following distance, the average speed of vehicles driving in neighboring lanes, the road curvature, the speed and the lateral acceleration of the host vehicle, and the intention of the at least one other vehicle determined by the intention-analyzing module, and the speed pre-adjusting module calculates a comfortable speed as the target speed when there is no vehicle around the host vehicle.

7. The active safety assistance system for pre-adjusting speed according to claim 1, wherein the target-following decision-making module comprises a lateral integrated decision-making module, a longitudinal integrated decision-making module, and a vehicle movement-limiting module, the lateral integrated decision-making module is configured to control the steering wheel, and the longitudinal integrated decision-making module is configured to control the throttle pedal and the brake force.

8. The active safety assistance system for pre-adjusting speed according to claim 7, wherein the lateral integrated decision-making module is configured to determine whether a lane line of the at least one lane exists, the lateral integrated decision-making module makes a decision for the host vehicle following a front vehicle or advancing along the lane line according to a result for detecting the front vehicle and makes a decision for the host vehicle driving at a center of the at least one lane when the lane line of the at least one lane exists, and the lateral integrated decision-making module makes a decision for the host vehicle following the front vehicle when the lateral integrated decision-making module fails to detect the lane line.

9. The active safety assistance system for pre-adjusting speed according to claim 7, wherein the longitudinal integrated decision-making module is configured to calculate a distance to collision and time to collision for the host vehicle and the at least one other vehicle, thereby making a decision for braking, accelerating, or decelerating.

10. The active safety assistance system for pre-adjusting speed according to claim 7, wherein the vehicle movement-limiting module is configured to calculate a vehicle speed for longitudinal limitation and a steering-wheel angle for lateral limitation according to decisions made by the lateral integrated decision-making module and the longitudinal integrated decision-making module.

11. A control method using an active safety assistance system for pre-adjusting speed, which is applied to an on-board system of a host vehicle, and when the control method detects at least one other vehicle around the host vehicle, the control method comprising:
using an other-vehicle trajectory estimation module to calculate a deviation amount of the host vehicle with respect to a lane center according to a plurality of environment-sensing data and estimate an other-vehicle trajectory of the at least one other vehicle;
using an intention-analyzing module to fit the other-vehicle trajectory to at least one lane to determine that the at least one other vehicle intends to advance in a same lane, turn in a same lane or switch over to another lane, fit the other-vehicle trajectory to a dynamic trajectory of the host vehicle to generate a fitted result, and determine whether the at least one other vehicle is used as at least one target vehicle that influences movement of the host vehicle according to the fitted result and an intention of the at least one other vehicle, and using the intention-analyzing module to calculate at least one control parameter for fixing distance, fixing speed, or pre-adjusting speed of the host vehicle when the at least one target vehicle exists;
using a speed pre-adjusting module to receive the at least one control parameter and use the at least one control parameter to cooperate with the deviation amount, a speed, a lateral acceleration, and a plurality of state data of the host vehicle to calculate a target speed of the host vehicle; and
using a target-following decision-making module to make decisions for a steering wheel, a throttle pedal and a brake force of the host vehicle according to an intention of the at least one target vehicle, the dynamic trajectory, the at least one control parameter, and the target speed.

12. The control method according to claim 11, wherein the at least one other vehicle comprises a front vehicle and neighboring vehicles in left and right lanes.

13. The control method according to claim 11, wherein the plurality of environment-sensing data comprise a vehicle-width recognition result, longitudinal and lateral relative speeds, and a relative distance of the at least one other vehicle, moving-state information of the host vehicle, a lane line-detecting result, and a lane-line model.

14. The control method according to claim 13, wherein the other-vehicle trajectory estimation module substitutes the plurality of environment-sensing data into a four-dimensional Euclidean coordinate transforming formula, combines time and space, and uses a representative formula of
$${P}_{i} ( t ) = {min}_{P} ( Σ ‖ P ( {t}^{-} ) - {x}_{i , {t}^{-}} ‖ )$$
to obtain a future trajectory of the at least one other vehicle, wherein x_{i,t} represents other-vehicle information of an i-th other vehicle at previous time t⁻ and P(t) is a quadratic function of time t.

15. The control method according to claim 13, wherein the other-vehicle trajectory estimation module combines time and space to generate a combined result, and the intention-analyzing module uses the combined result to determine that the at least one other vehicle drives at an inside of a lane where the host vehicle presently drives, left of an outside of a lane where the host vehicle presently drives, or right of an outside of a lane where the host vehicle presently drives, thereby performing a lane-fitting process.

16. The control method according to claim 11, wherein the plurality of state data comprise a vehicle-following distance that the host vehicle follows the at least one other vehicle, an average speed of vehicles driving in neighboring lanes, and a road curvature, the speed pre-adjusting module determines whether a distance between the host vehicle and the at least one other vehicle is within a safe range to adjust the speed of the host vehicle and obtain the target speed according to the vehicle-following distance, the average speed of vehicles driving in neighboring lanes, the road curvature, the speed and the lateral acceleration of the host vehicle, and the intention of the at least one other vehicle determined by the intention-analyzing module, and the speed pre-adjusting module calculates a comfortable speed as the target speed when there is no vehicle around the host vehicle.

17. The control method according to claim 11, wherein the target-following decision-making module comprises a lateral integrated decision-making module, a longitudinal integrated decision-making module, and a vehicle movement-limiting module, the lateral integrated decision-making module is configured to control the steering wheel, and the longitudinal integrated decision-making module is configured to control the throttle pedal and the brake force.

18. The control method according to claim 17, wherein the lateral integrated decision-making module is configured to determine whether a lane line of the at least one lane exists, the lateral integrated decision-making module makes a decision for the host vehicle following a front vehicle or advancing along the lane line according to a result for detecting the front vehicle and makes a decision for the host vehicle driving at a center of the at least one lane when the lane line of the at least one lane exists, and the lateral integrated decision-making module makes a decision for the host vehicle following the front vehicle when the lateral integrated decision-making module fails to detect the lane line.

19. The control method according to claim 17, wherein the longitudinal integrated decision-making module is configured to calculate a distance to collision and time to collision for the host vehicle and the at least one other vehicle, thereby making a decision for braking, accelerating, or decelerating.

20. The control method according to claim 17, wherein the vehicle movement-limiting module is configured to calculate a vehicle speed for longitudinal limitation and a steering-wheel angle for lateral limitation according to decisions made by the lateral integrated decision-making module and the longitudinal integrated decision-making module.
